(19) United States
(12) Patent Application Publication
(10) Pub. No.: US 2007/0227309 A1
(43) Pub. Date: Oct. 4, 2007

(54) Hose Clamp Tool

(76) Inventor: David Teeters, Lake Helen, FL (US)

Correspondence Address: Robert L Wolter;Beusse Wolter Sanks Mora & Maire, P.A., Suite 2500, 390 North Orange Avenue, Orlando, FL, 32801, US

(21) Appl. No.: 11/692,605

(22) Filed: Mar. 28, 2007

Related U.S. Application Data
(60) Provisional application No. 60/787,574, filed on Mar. 30, 2006.

(51) Int. Cl. B25B 27/10

(52) U.S. Cl. 81/9.3

(57) ABSTRACT

A hose clamp tool for engaging and supporting a hose clamp has a handle a shaft operable connected to the handle. A support member is positioned in spaced relation to the shaft and supported there on by a biasing member that biases the support member toward the tool handle. The support member includes a first shoulder disposed toward the handle and a second shoulder spaced from the first shoulder toward a second end of the shaft. When support member is biased away from the handle, a gap is formed between the second end of the shaft and the second should of the support for receiving a bolt on the hose clamp. The second end of the shaft engages the bolt and the support member is released and biased toward the handle so the second shoulder engages the hose clamp at an end of the bolt opposite the bolt head.

### CROSS-REFERENCE TO RELATED APPLICATIONS

This application claims priority to U.S. Provisional Application No. 60/787,574 filed Mar. 30, 2006.

### BACKGROUND OF THE INVENTION

This invention pertains to tools used to install, tighten, loosen or remove hose clamps. More specifically, the invention relates to tools that enable one to access a hose clamp in hard to reach positions and/or tools that enable one to install or remove a hose clamp using only one hand.

A hose clamp typically includes a pliable metal strip that has two ends overlapping one another forming a circle. An anchor secures the overlapping sections of the metal strip together. In addition, a bolt is secured to the metal strip at the anchor. Threads on the bolt are positioned in mating relationship with slots formed in the metal strip. Accordingly, when a drive tool as a screw driver or wrench engages a head on the bolt and rotates the bolt, the ends of the strip move relative to one another tightening or loosening depending on the direction of rotation of the bolt. If the clamp is loosely fitted around a hose, the metal strip may rotate or move on the hose when one rotates the bolt, and one must use his/her free hand to prevent rotation of the clamp on the hose. In those instances where the hose clamp is located in a hard-to-reach position, using one's second hand to hold the hose clamp may be difficult if not virtually impossible.

### BRIEF DESCRIPTION OF THE INVENTION

In an embodiment of the invention, a hose clamp tool is designed for engaging a hose clamp having a bolt for tightening or loosening the hose clamp wherein the bolt has a bolt head and bolt end opposite or distal the bolt head. The hose clamp tool comprises a handle and a shaft that has a first end attached to the handle, and a second end distal the first end. The shaft is operably connected to the handle for rotation in a direction the handle is rotated, and the second end is adapted for engaging the bolt head of the bolt on the hose clamp. A support member is operably connected to the shaft and handle for supporting a hose clamp and has a longitudinal axis substantially parallel to a longitudinal axis of the shaft. The support member is moveable along its longitudinal axis and rotatable on the shaft and such movement is independent of movement of the shaft and handle. A means is disposed between the shaft and support member for biasing the support member toward the handle. In addition, the support member has a spine in spaced relation to the shaft and has a first end adjacent to the handle, a first shoulder depending from the spine over the shaft in spaced relation to the shaft and engages the biasing means, a second shoulder depends from the spine in spaced relation to the first shoulder forming a gap there between for insertion of the bolt on the hose clamp and said second shoulder engages the hose clamp opposite the bolt head.

In use, an operator biases the support member toward the second end of the shaft or away from the handle forming a gap between the second end of the shaft and second shoulder of the support member. The bolt on the hose clamp is positioned in the gap with the second of the shaft engaging the bolt head. The support member is released and biased toward the handle whereby the second shoulder of the support member engages the hose clamp at space between the bolt and the metal strip of the hose clamp. The hose clamp may then be tightened or loosened as desired.

### DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a perspective view of a hose clamp.

FIG. 2 is an end view of the hose clamp.

FIG. 3 is a perspective view of the invention.

FIG. 4 is a side view of the invention.

FIG. 5 is a bottom view of the invention.

FIG. 6 is a bottom sectional view of the invention engaging a hose clamp

FIG. 7 is a side view of the invention adjusted to receive a hose clamp.

FIG. 8 is a side view of the invention engaging a hose clamp.

FIG. 9 is a bottom view of the invention engaging a hose clamp.

FIG. 10 is a perspective view of a second embodiment of the invention

FIG. 11 is a sectional view of the second embodiment of the invention

FIG. 12 is a perspective view of the invention with an adapter.

FIG. 13 is a perspective view of the invention with an adapter.

FIG. 14 is a sectional view of a third embodiment of the invention.

### DESCRIPTION OF THE INVENTION

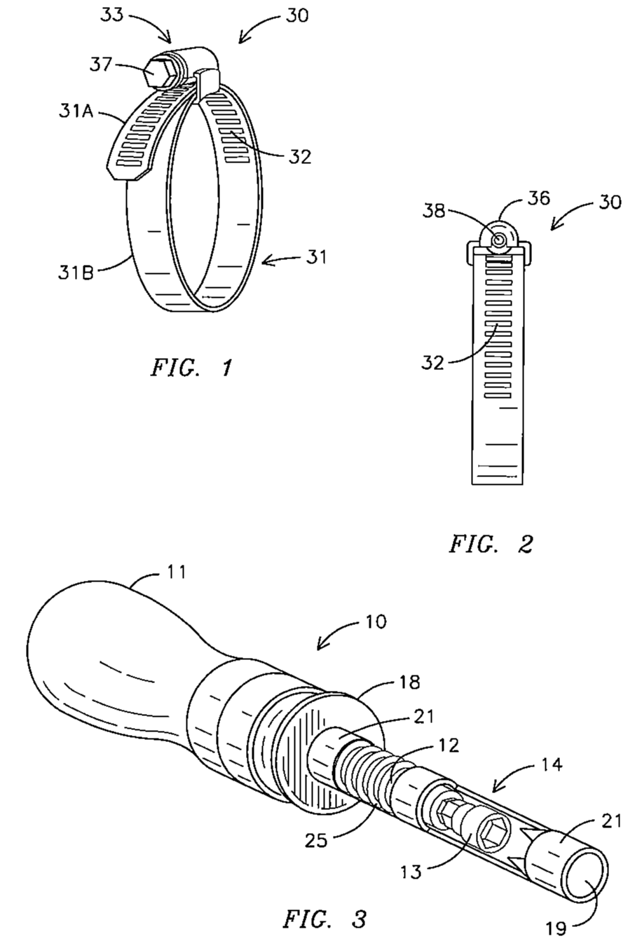

A hose clamp 30 is illustrated in FIGS. 1 and 2, and includes a metal strip 31 having a first portion 31A rolled over the top of a second portion 31A in a generally circular configuration for receiving a hose (not shown). The first portion 31A and second portion 31B are secured together, in sliding relationship to one another, by an anchor 36, which also secures a bolt 33 to the first portion 31A of the metal strip 31. The bolt 33 has threads (not shown) that are positioned in mating relationship with slots 32 on the first portion 31A of the metal strip 31. The bolt 33 has a head 37 for receiving a tool such as a screwdriver, ratchet, wrench or any other tool used to rotate the bolt 33. When one rotates the bolt 33, the threads engage metal strip 31 at the slots 32 causing the clamp 30 to tighten or loosen depending on which direction the bolt 33 is rotated.

The invention for a hose clamp tool 10 is depicted in FIGS. 3 through 5, and includes a shaft 12 mounted to a handle 11. The shaft 12 is operably connected to the handle 11 in such a manner that the shaft 12 rotates in the same direction as the rotation of the handle 11 as selected by a user. The shaft 12 may be detachable from the handle 11. The shaft 12 includes a first end 12A mounted to the handle 11 and a second end 12B distal the first end 12A. A bit 13 is secured to the second end 12A of the shaft 12 for engaging the bolt head 37 of the hose clamp 30. In an embodiment, the bit 13 is detachable from the shaft 12 so that different sized and shaped bits may be used with the tool 10. For example flat head or Philips head screwdriver bits, hexagonal wrench bits or alien wrench bits may be interchangeably used on the tool. In such cases, the second end 12B of the shaft 12 may be adapted to include a magnetic coupling or it is machined for receiving and end of the bit 13 in such a manner to adequately secure the bit 13 to the shaft 12 for operation.

With respect to FIGS. 3 through 5, the tool 10 comprises a support member 14 for supporting the hose clamp 30 on the tool 10. The support member 14 is positioned over the shaft 12 and has a longitudinal axis parallel to a longitudinal axis of the shaft 12. The support member 14 is movable along its longitudinal axis, and rotates with respect to and independent from movement of the shaft 12. The support member 14 preferably includes a spine 24; a first shoulder 20 that depends from the spine 24 that is positioned in spaced relation with respect to bit 13 toward the handle 11; and, a second shoulder 21 depends from the spine 24 and is positioned in spaced relation with respect to the first shoulder 20 toward the bit 13 forming a gap 34 there between for insertion of the bolt 33 on the hose clamp 30.

The first shoulder 20 and second shoulder 21 preferably have an arched or cylindrical configuration forming an opening 19 in the second shoulder 21 for receiving the bolt end 38 on the hose clamp 30. Rotation of the support member with respect to, and independent from the shaft 12 or handle 11 enables one to engage a hose clamp 30 remotely positioned in such a manner that the bolt 33 is not aligned with the gap 34 for engagement of the hose clamp 30. In such a case, the support member 14 is rotated to a position so the gap 34 is aligned with the bolt 33 for receiving the hose clamp 30. While the support member 14 may be fixed in a single position, or non-rotatable with respect to the shaft, such an embodiment may limit one's ability to engage a hose clamp 30 remotely positioned.

At least a portion of the spine 24 between the first shoulder 20 and second shoulder 21 has an arched configuration forming side edge 26 between the first shoulder 20 and second shoulder 21. When the tool 10 engages a hose clamp 30, the handle 11 and shaft 12 are rotated to turn the bolt 33. The hose clamp 30 may also rotate when secured in the tool 10. When the hose clamp 30 rotates it engages the side edge 26, which prevents further rotation of the hose clamp 30 during operation of the tool 10. In addition, the tool 10 may have teeth 41 connected to the second shoulder 21 and extend toward the handle 11. The teeth 41 engage the hose clamp 30 at the space between an end of the bolt 33 opposite the bolt head 37 and the metal strip 31 to secure the hose clamp 30 to the tool 10, and prevent rotation of the hose clamp 30 on the tool 10 during operation.

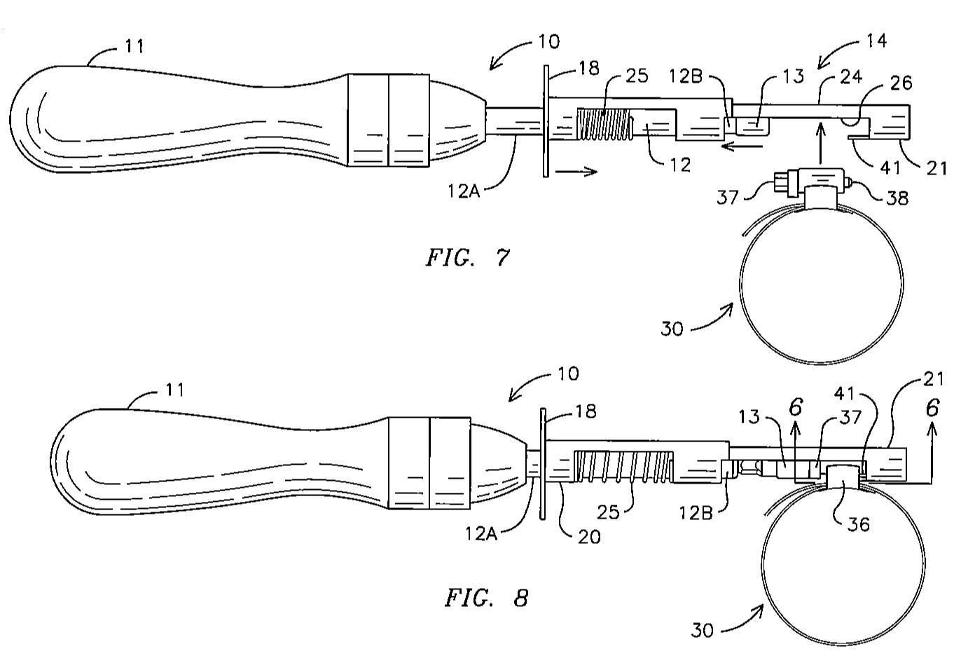

A means for biasing the support member 14 toward the handle 11 is disposed between the support member 14 and shaft 12. In the embodiment shown in FIGS. 3 through 5, a spring 25 is incorporated to bias the support member 14 toward the handle 11. In use, the support member 14 is advanced in a direction toward the bit 13 creating a space between the bit 13 and second shoulder 21 sufficient to insert the bolt 33 on the hose clamp 30 as shown in FIGS. 7 and 8. In an embodiment, a projection 18 is affixed to the first end 15 of the support member 14 adjacent to the handle 11. The projection 18 shown in FIG. 3 is a disc-like member so that the support member 14 may be rotated and advanced at any number of positions. The projection 18 is not intended to be limited to a disc-like member but may include other design such as a single finger-like projection, or plurality such projections spaced apart from one another. The diameter of the projection may also vary. In addition, the invention does not require the projection 18 to function, and is operable without the projection 18, which provides means for engaging and advancing the support member 14.

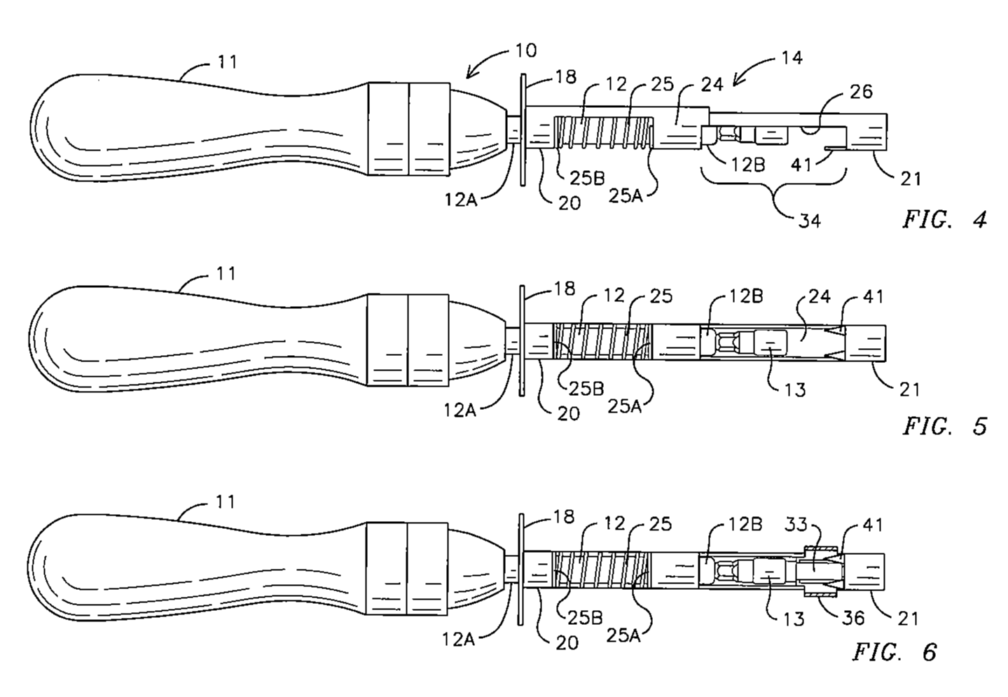

With respect to the embodiment shown in FIGS. 3 and 4, the shaft 12 has a substantially uniform diameter. Accordingly, that section of the spine 24 positioned over the spring 25 is displaced outwardly with respect a section of the spine that does not cover the spring 25 in order to accommodate the spring 25. A first end 25A of the spring 25 is affixed to the shaft 12. When the support member 14 is advanced in a direction toward the bit 13, a second end 25B of the spring 25 engages the first shoulder 20 on spine 24 causing the spring 25 to compress. After the bolt 33 on the hose clamp 30 is inserted so the bit 13 engages the bolt head 37, the projection 18 is released; the spring 25 biases the support member 14 toward the handle 11 and the second shoulder 21 on the spine 24 engages the hose clamp 30 at the space between bolt 33 and metal strip 31 of the hose clamp 30.

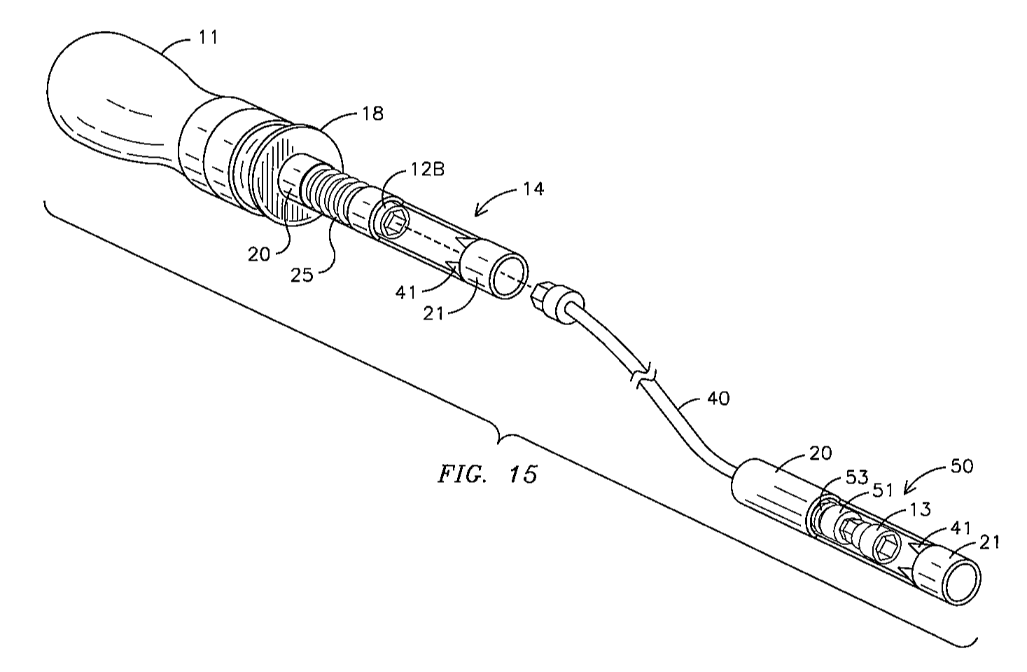

In another embodiment, shown in FIG. 14, the shaft 12 may have a first section 16 that has a diameter smaller than a diameter of a second section 17. The spring 25 is positioned over the first section 16. When the support member 14 is advanced in a direction toward the bit 13, the first shoulder 20 engages the spring 25 compressing the spring 25 against the second section 17 of the shaft 12. The first shoulder 20 has at least one engagement member or flange 42 projecting inwardly for engaging the spring 25 when the support member 14 is advanced. When support member 14 is released the spring 25 biases the support member 14 toward the handle and the hose clamp 30 is secured to the tool 18 when the second shoulder 21 engages the hose clamp 30 between bolt end 38 and the metal strip 31.

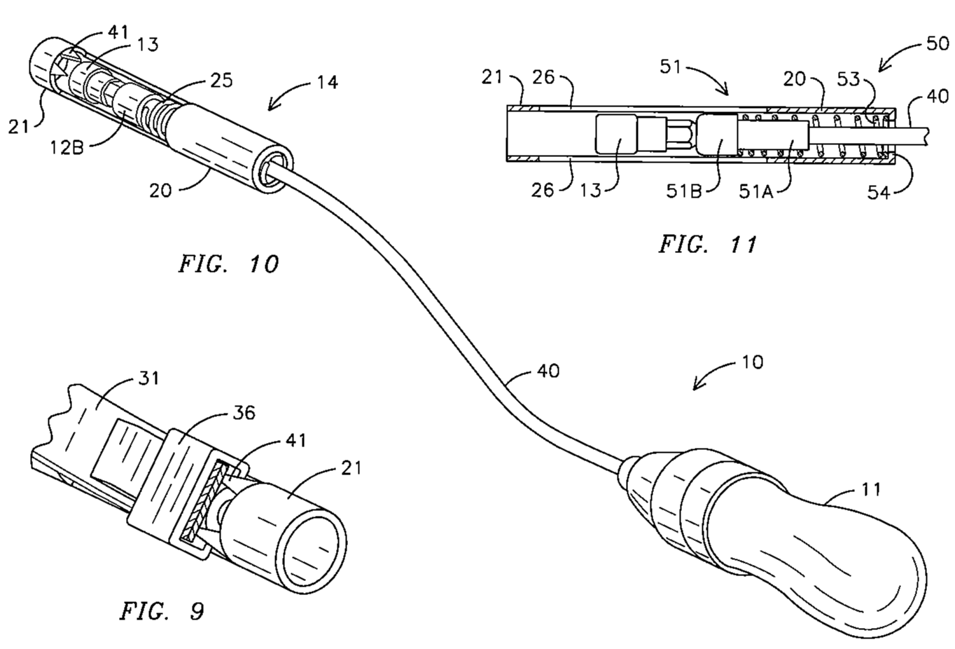

With respect to FIG. 10, an embodiment of the tool 10 is illustrated. The tool 10 includes an elongated flexible shaft portion 40, which may allow access to hose clamps remotely positioned in hard to reach places. The portion 40 attached at a first end to the handle 11, and attached at a second end to the shaft 12. The flexible portion 40 is operably connected to the handle 11, and rotates in same direction of rotation of the handle 11 during operation. In an embodiment shown in FIG. 15, the flexible shaft portion 40 is attached to shaft 12 of the tool 10 in a similar fashion as the bit 13 in previously described embodiments.

With respect to FIGS. 11 and 15 the flexible portion 40 has more rigid end 51 adapted for receiving bit 13 for engaging a hose clamp 30. A second support member 50 is attached and positioned in spaced relation to the rigid end 51 and or flexible portion 40. The end 51 includes a first section 51A having a diameter that is smaller than a diameter of a second section 51B. A second spring 53 is disposed between the support member 50 and the narrower first section 51A. The support member 51 has the spaced apart first shoulder 20 and second shoulder 21, and an inwardly projection flange 54 on the first shoulder 21. When the support member 50 is advanced over the end 51, the flange 54 engages the spring 53 compressing it. In addition, the second shoulder 21 is spaced a sufficient distance to insert the bolt 33 into the support member 51 between the bit 13 and the second shoulder 21. When the support member 51 is released the spring 53 biases the support member 51 toward the flexible portion 40 by engaging the flange 54. The second shoulder 21 engages the hose clamp 30 as described above.

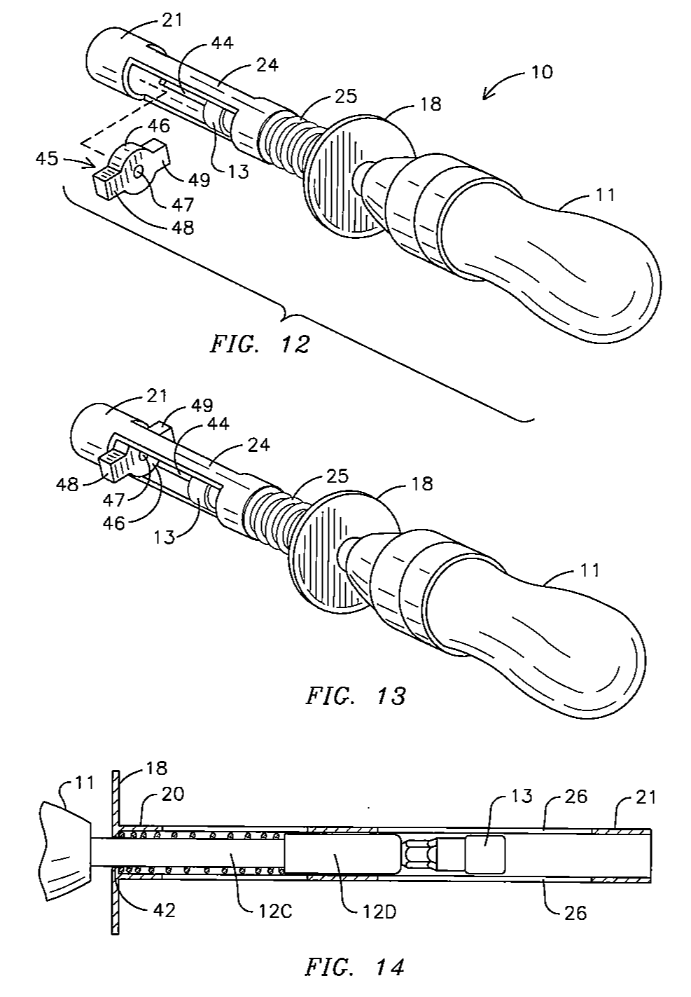

Yet another embodiment of the invention is illustrated in FIGS. 12 through 13, the support member 14 includes a first and second spine member 24A and 24B which are spaced apart forming the opposing openings or gaps 44 for insertion of the hose clamp 30 in the tool 10 between the bit 13 and the second shoulder 22. This embodiment may enable one to more readily insert the hose clamp 30 as the support member 14 may not have to be rotated as much to find a position for insertion of the hose clamp 30. With respect to FIGS. 12 and 13, an adaptor 45 is illustrated for use with the hand tool 10. The adaptor 45 is intended for use with hose clamps 30 with bolts 33 having diameters so the second shoulder 21 may not effectively engage the hose clamp 30 and secure the same to the tool 10. The adaptor 45, shown in FIG. 12 as a body portion 46 within which an aperture or recess 47 is formed for receiving the bolt end 38. The adaptor 45 has two opposing wings 48 and 49, and is preferably magnetized to secure the same on the tool 10. As shown in FIG. 13 the adapter 45 is attached to the second shoulder 21 of the support member 14 so the wings 48 and 49 fit within respective gaps 44 of the support member 14 to minimize rotation of the adaptor 45 and hose clamp 30 during operation of the tool 10. While the adaptor 45 is intended for use with smaller diameter bolts, the tool 10 may be used with any sized adaptor 45 that may fit any sized bolts on hose clamps.

The adaptor 45 is not limited to the configuration shown in FIGS. 12 and 13 as described above, but may include any variety of shapes or sizes operable with the tool 10. For example, an adaptor 45 may have only a single wing that fits within the gap 34 on the embodiment shown in FIGS. 3 through 5. In addition, the adaptor 45 may not have any wing members. In such a case, the second shoulder 21 or end of the support member 14 may be equipped with engagement members (not shown) that extend inwardly to support the adaptor in the support member 14.

While the preferred embodiments of the present invention have been shown and described herein, it will be obvious that such embodiments are provided by way of example only and not of limitation. Numerous variations, changes and substitutions will occur to those skilled in the art without departing from the teaching of the present invention. Accordingly, it is intended that the invention be interpreted within the full spirit and scope of the appended claims.

What is claimed is:

1. A hose clamp tool for engaging a hose clamp having a bolt for tightening or loosening the hose clamp, the bolt having a bolt head and bolt end, the tool comprising:
a handle;
a shaft having a first end attached to the handle, and a second end distal the first end, and the shaft operably connected to the handle for rotation in a direction the handle is rotated, and the second end is adapted for engaging the bolt head of the bolt on the hose clamp;
a support member, operably connected to the shaft and handle, for supporting a hose clamp, having a longitudinal axis substantially parallel to a longitudinal axis of the shaft, and the support member is moveable along the longitudinal axis and rotatable on the shaft and such movement being independent of movement of the shaft and handle;
means, disposed between the shaft and support member, for biasing the support member toward the handle; and,
the support member having a spine in spaced relation to the shaft and having a first end adjacent to the handle, a first shoulder depending from the spine over the shaft in spaced relation to the shaft and engaging the biasing means, a second shoulder depending from the spine in spaced relation to the first shoulder forming a gap therebetween for insertion of the bolt on the hose clamp and said second shoulder engaging the hose clamp opposite the bolt head.

2. The hose clamp tool of claim 1 further comprising at least two projections connected to the second shoulder extending toward the first shoulder and spaced apart from one another for engaging the hose clamp at a space between the bolt and a metal strip of the hose clamp and the anchor holding the bolt on the metal strip.

3. The hose clamp tool of claim 1 wherein the first and second shoulders have a hollow cylindrical configuration and the shaft extends through the first shoulder and the biasing means includes a spring having a first end secured to the shaft and an edge of the first shoulder engages the first end of the spring when the support member is advanced toward the second end of the shaft causing the spring to compress, and the second shoulder having an edge that is spaced from the second end of the shaft forming a gap for receiving the bolt of the hose clamp in the tool.

4. The hose clamp tool of claim 3 further comprising a disc-like engagement member mounted to the support and extending outward there from.

5. The hose clamp tool of claim 1 wherein the first and second shoulders have a hollow cylindrical configuration and the shaft extends through the first shoulder and the biasing means includes a spring having a first end engaging an inwardly disposed flange on the first shoulder and when the support member is advanced toward the second end of the shaft the flange engages the second end of the spring causing the spring to compress, and the second shoulder having an edge that is spaced from the second end of the shaft forming a gap for receiving the bolt of the hose clamp in the tool.

6. The hose clamp tool of claim 5 further comprising a disc-like engagement member mounted to the support member adjacent the handle and extending outward there from.

7. The hose clamp tool of claim 5 wherein at least a portion of the first end of the shaft has a diameter that is smaller than a diameter of at least a portion of the second end of the shaft of the tool such that the second end of the spring engages the second end of shaft when compressed.

8. The hose clamp tool of claim 1 further comprising two opposing side edges on the spine disposed between the first shoulder and second shoulder wherein the side edges minimize rotation of the hose clamp on a hose when being adjusted by the hose clamp engaging one of the size edges.

9. The hose clamp tool of claim 1 wherein the support member includes a first and second opposing spine member spaced apart from one and disposed between the first shoulder and second shoulder and first shoulder has a hollow cylindrical configuration through which the shaft of the tool and extends, and the second shoulder has a hollow cylindrical configuration in which an end of the hose clamp bolt is inserted and forming gap between the first and second spine members and first and second should for insertion of the bolt.

10. The hose clamp tool of claim 9 further comprising a body portion with a recess for receiving an end of the bolt, and two wing members integral the body portion and disposed in the gap between the first and second spine members.

11. A hose clamp tool for engaging a hose clamp having a bolt for tightening or loosening the hose clamp, the bolt having a bolt head and bolt end, the tool comprising:
a handle;
a shaft having a first end attached to the handle, and a second end distal the first end, and the shaft operably connected to the handle for rotation in a direction the handle is rotated, and the second end is adapted for engaging the bolt head of the bolt on the hose clamp;
a support member, operably connected to the shaft and handle, for supporting a hose clamp, having a longitudinal axis substantially parallel to a longitudinal axis of the shaft, and the support member is moveable along the longitudinal axis and rotatable on the shaft and such movement being independent of movement of the shaft and handle;
means, disposed between the shaft and support member, for biasing the support member toward the handle; and,
the support member having a spine in spaced relation to the shaft and having a first end adjacent to the handle, a first shoulder depending from the spine and having a hollow cylindrical configuration in which a least a portion of the biasing means disposed and the first shoulder, a second shoulder depending from the spine in spaced relation to the first shoulder forming a gap there between for insertion of the bolt on the hose clamp and the second shoulder having a hollow cylindrical configuration engaging the hose clamp opposite the bolt head, and the first shoulder engaging the spring when the support member is advanced longitudinally toward an end of the shaft.

12. The hose clamp tool of claim 11 further comprising at least two projections connected to the second shoulder extending toward the first shoulder and spaced apart from one another for engaging the hose clamp at a space between the bolt and a metal strip of the hose clamp and the anchor holding the bolt on the metal strip.

13. The hose clamp tool of claim 11 further comprising a disc-like engagement member mounted to the support and extending outward there from.

14. The hose clamp tool of claim 11 wherein the biasing means includes a spring having a first end engaging an inwardly disposed flange on the first shoulder and when the support member is advanced toward the second end of the shaft the flange engages the second end of the spring causing the spring to compress, and the second shoulder having an edge that is spaced from the second end of the shaft forming a gap for receiving the bolt of the hose clamp in the tool.

15. The hose clamp tool of claim 14 further comprising a disc-like engagement member mounted to the support member adjacent the handle and extending outward there from.

16. The hose clamp tool of claim 11 wherein at least a portion of the first end of the shaft has a diameter that is smaller than a diameter of at least a portion of the second end of the shaft of the tool such that the second end of the spring engages the second end of shaft when compressed.

17. The hose clamp tool of claim 11 further comprising two opposing side edges on the spine disposed between the first shoulder and second shoulder wherein the side edges minimize rotation of the hose clamp on a hose when being adjusted by the hose clamp engaging one of the size edges.

18. The hose clamp tool of claim 11 wherein the support member includes a first and second opposing spine member spaced apart from one and disposed between the first shoulder and second shoulder and first shoulder has a hollow cylindrical configuration through which the shaft of the tool and extends, and the second shoulder has a hollow cylindrical configuration in which an end of the hose clamp bolt is inserted and forming gap between the first and second spine members and first and second should for insertion of the bolt.
